(19) United States
(12) Patent Application Publication
(10) Pub. No.: US 2008/0162314 A1
(43) Pub. Date: Jul. 3, 2008

(54) Financial product

(76) Inventor: Prasanth Seevnarayan, Rosebury (AU)

Correspondence Address: LADAS & PARRY LLP, 26 WEST 61ST STREET, NEW YORK, NY, 10023, US

(21) Appl. No.: 11/895,270

(22) Filed: Aug. 22, 2007

Related U.S. Application Data
(60) Provisional application No. 60/839,471, filed on Aug. 23, 2006.

(51) Int. Cl. G06Q 40/00

(52) U.S. Cl. 705/35

(57) ABSTRACT

This invention provides various financial products and methods of investing. According to a first aspect an investor is able to invest funds that are linked to a commodity, and the investor is then able to switch from one currency to another. According to a second aspect, the investor is able to switch from one commodity to another. According to a third aspect the investor is paid interest by an institution with whom the funds have been invested and which has acquired a commodity in accordance with the value of the funds. The interest rate may be fixed or variable.

This invention relates to a financial product and a method of investing. More particularly it relates to a commodity based financial product and investment method.

According to a first aspect of the invention there is provided a financial product which includes

an initial investment by an investor of funds in an amount of a commodity in a first currency;

a subsequent linking by the investor of the said amount of the commodity to a second currency; and

thereafter valuing the said amount of the commodity in the second currency.

Further according to the first aspect of the invention there is provided a method of investing in a commodity which includes

initially investing funds by an investor in a first currency with a financial institution which is associated with an amount of the commodity in accordance with the prevailing price of the commodity in the first currency; and

subsequently linking the said amount of the commodity to a second currency such that thereafter the said amount of the commodity is valued at the price extant in the second currency.

Still further according to the first aspect of the invention there is provided a method of investing in a commodity, which includes

initially receiving funds in a first currency from an investor;

associating an amount of the commodity in accordance with the prevailing price of the commodity in the first currency;

subsequently linking the said amount of the commodity to a second currency determined by the investor; and

thereafter valuing the said amount of the commodity at the price extant in the second currency.

According to a second aspect of the invention there is provided a financial product which includes

an initial investment by an investor of funds in an amount of a first commodity;

a subsequent linking by the investor of the value of the amount of the first commodity at that time to an amount of a second commodity in accordance with the value of the second commodity at that time; and

thereafter valuing the said amount of the second commodity

Further according to the second aspect of the invention there is provided a method of investing in commodities which includes

initially investing funds with a financial institution by an investor which is associated with an amount of a first commodity in accordance with the prevailing price of the first commodity; and

subsequently linking the value of the said amount of the first commodity at that time to a second commodity such that thereafter the investment is valued at the price extant of the second commodity.

Still further according to the second aspect of the invention there is provided a method of investing in commodities, which includes

Initially receiving funds from an investor;

determining an amount of a first commodity at the prevailing price of the commodity in accordance with the value of the funds received;

subsequently linking the value of the said amount of the first commodity at that time to a second commodity to determine an amount of the second commodity; and

thereafter valuing the investment in accordance with the value of the amount of the second commodity at the price extant thereafter.

According to a third aspect of the invention there is provided a financial product which includes

an investment by an investor of funds in an amount of a commodity; and

payment of interest at a predetermined rate in respect of the funds invested.

Further according to the third aspect of the invention there is provided a method of investing in a commodity which includes

investing funds with a financial institution which are utilised by the institution to purchase an amount of the commodity in accordance with the prevailing price of the commodity; and

receiving interest from the institution at a predetermined rate in respect of the funds invested.

Still further according to the third aspect of the invention there is provided a method of investing in a commodity, which includes

receiving funds from an investor;

purchasing an amount of the commodity in accordance with the prevailing price of the commodity; and

paying the investor interest at a predetermined rate in respect of the funds invested.

The interest rate may be fixed or variable. It will be appreciated that the interest will depend on the currency in which the funds are received and the denominated currency for the commodity. It will be appreciated still further that the third aspect of the invention may be combined with either or both the first and second aspects.

The interest may be paid in the first currency or the interest may be used to purchase more of the commodity at the price extant when the interest accrues.

The commodity may be a precious metal such as gold, platinum or silver; or a base metal such as copper or iron, or any other traded commodity such as wheat, oil, paper, or the like.

Those skilled in the art will appreciate that the institution could buy either the physical commodity or a related derivative instrument.

The product may be for a predetermined investment period.

The product and the methods according to the first aspect may include the ability to switch back to the first currency or to a further currency. Similarly, the product and the methods according to the second aspect may include the ability to switch back to the first commodity or to a further commodity. A number of available commodities and currencies may be specified by the institution and the investor may then, from time to time, select the currency and commodity in which he wishes to invest. The product according to the first and second aspects may prescribe set times when the investor may switch and the number of times that he may do so. A prescribed charge may be levied by the institution when the investor switches. Clearly, the products and methods in accordance with the first and second aspects may be combined.

The products and the methods may also include payment to the investor, at the end of the investment period, the value of the amount of the commodity at that time, in the currency that is linked to the said amount at that time, or in the first currency at the exchange rate prevailing then. Instead, the products and methods may include delivery to the investor, at the end of the investment period, of the amount of the commodity held at that time.

It will be appreciated that a financial institution offering or underwriting the products would be responsible for buying the commodity or related derivative instrument to hedge the recovery of the investment plus interest or the physical commodity and for pricing the interest rate to be received by the investor, dependent on the commodity, the volumes, timing of the investment and the linked currency chosen by the investor.

It will be appreciated further that the financial product involves speculation on a combination of commodity and currency markets with an interest rate redeemable at any time in a base currency or any currency into which the base currency is converted at the time of the realization of the investment.

The invention is now described by way of the following non-limiting examples.

In a first example, a South African investor purchases 1 ounce of gold for R3,500, assuming that the price is R3,500 per ounce. He elects for the base currency to be in US dollars. Thus, the value of the gold is $500.00 assuming an exchange rate of R7:US$1, being the prevailing exchange rate at the time of the purchase of the gold. A year later, the price of gold is US$600, per ounce, such that the value of the gold is US$600. For this period the investor receives interest at the rate of 2%, such that the value of the investment becomes US$612. Another 0.02 ounces of gold is purchased and added to the gold held so that the institution now holds 1.02 ounces.

The investor decides to switch to Euros. Thus, at that time the value becomes £501.64, based on a US dollar-Euro exchange rate of 1.22. As the investment is now Euro denominated, the interest rate becomes 1.5% per annum. A year later, the Euro price of gold is £500 per ounce, so that the 1.02 ounces of gold is worth £510. The interest is £7.65 so another 0.015 ounces of gold is purchased so that the institution holds 1.035 ounces. The investor may then withdraw the 1.035 ounces of gold or the £517.65. Alternatively, in a country such as South Africa where there is exchange control, the investor may withdraw R4,658.85, assuming an exchange rate of R9:£1.

In a second example, A South African investor purchases 1 ounce of gold for R3,500, assuming that the price is R3,500 per ounce. He elects for the base currency to be in US dollars. Thus, the value of the gold is $500.00 assuming an exchange rate of R7:US$1, being the prevailing exchange rate at the time of the purchase of the gold. A year later, the price of gold is US$600, per ounce, such that the value of the gold is US$600. For the first six months the investor receives interest at the rate of 2%, and thereafter at 3%, such that the value of the investment becomes US$615.

The investor decides to switch to platinum. Thus, at the time of the switch, the investor will acquire US$615 worth of platinum. A year later, the dollar price of the platinum is US$700. The investor may then withdraw the US$700 or US$700 worth of platinum. Alternatively, in a country such as South Africa where there is exchange control, the investor may withdraw R4,900,00, assuming an exchange rate of R9:1.

1. A financial product which includes
an initial investment by an investor of funds in an amount of a commodity in a first currency;
a subsequent linking by the investor of the said amount of the commodity to a second currency; and
thereafter valuing the said amount of the commodity in the second currency.

2. The financial product as claimed in claim 1, which is for a predetermined investment period.

3. The financial product as claimed in claim 1, in which the second currency is selected by the investor.

4. The financial product as claimed in claim 1, in which the commodity is selected by the investor.

5. The financial product as claimed in claim 2, in which the value of the said amount of the commodity at the end of the investment period is paid to the investor in the second currency.

6. The financial product as claimed in claim 1, in which the time when linking of the said amount of the commodity to the second currency is selected by the investor.

7. A method of investing in a commodity which includes
initially investing funds by an investor in a first currency with a financial institution which is associated with an amount of the commodity in accordance with the prevailing price of the commodity in the first currency; and
subsequently linking the said amount of the commodity to a second currency such that thereafter the said amount of the commodity is valued at the price extant in the second currency.

8. The method as claimed in claim 7, which includes purchasing the said amount of the commodity by the financial institution.

9. A method of investing in a commodity, which includes
initially receiving funds in a first currency from an investor;
associating an amount of the commodity in accordance with the prevailing price of the commodity in the first currency;
subsequently linking the said amount of the commodity to a second currency determined by the investor; and
thereafter valuing the said amount of the commodity at the price extant in the second currency.

10. The method as claimed in claim 9, which includes purchasing the said amount of the commodity.

11. The method as claimed in claim 7, in which the second currency is selected by the investor.

12. The method as claimed in claim 7, in which the commodity is selected by the investor.

13. The method as claimed in claim 7, in which the time when the said amount of the commodity is linked to the second currency is selected by the investor.

14. A financial product which includes
an initial investment by an investor of funds in an amount of a first commodity;
a subsequent linking by the investor of the value of the amount of the first commodity at that time to an amount of a second commodity in accordance with the value of the second commodity at that time; and
thereafter valuing the said amount of the second commodity.

15. The financial product as claimed in claim 14, which is for a predetermined investment period.

16. The financial product as claimed in claim 15, in which the value of the amount of the second commodity at the end of the investment period is paid to the investor.

17. The financial product as claimed in claim 15, in which the amount of the second commodity is delivered to the investor at the end of the investment period.

18. The financial product as claimed in claim 14, in which the first commodity is selected by the investor.

19. The financial product as claimed in claim 14, in which the second commodity is selected by the investor.

20. The financial product as claimed in claim 14, in which the time when the value of the amount of the first commodity is linked to the second commodity is selected by the investor.

21. A method of investing in commodities which includes
initially investing funds with a financial institution by an investor which is associated with an amount of a first commodity in accordance with the prevailing price of the first commodity; and
subsequently linking the value of the said amount of the first commodity at that time to a second commodity such that thereafter the investment is valued at the price extant of the second commodity.

22. The method as claimed in claim 21, which includes purchasing the first commodity, and then selling the first commodity and buying the second commodity by the financial institution.

23. A method of investing in commodities, which includes
initially receiving funds from an investor;
determining an amount of a first commodity at the prevailing price of the commodity in accordance with the value of the funds received;
subsequently linking the value of the said amount of the first commodity at that time to a second commodity to determine an amount of the second commodity; and
thereafter valuing the investment in accordance with the value of the amount of the second commodity at the price extant thereafter.

24. The method as claimed in claim 23, which includes purchasing the first commodity, and then selling the first commodity and buying the second commodity by the financial institution.

25. The method as claimed in claim 28, in which the first commodity is selected by the investor.

26. The method as claimed in claim 21, in which the second commodity is selected by the investor.

27. The method as claimed in claim 21, in which the time when the value of the said amount of the first commodity is linked to the second commodity is selected by the investor.

28. A financial product which includes
an investment by an investor of funds in an amount of a commodity; and
payment of interest at a predetermined rate in respect of the funds invested.

29. The financial product as claimed in claim 28, in which the rate is variable.

30. The financial product as claimed in claim 28, in which the rate is fixed.

31. The financial product as claimed in claim 28, in which the interest is paid in a designated currency.

32. The financial product as claimed in claim 28, in which the interest is used to purchase more of the commodity at the price extant when the interest accrues.

33. The financial product as claimed in claim 28, which is for a predetermined investment period.

34. The financial product as claimed in claim 33, in which the investor is paid the value of the commodity as at the end of the investment period.

35. The financial product as claimed in claim 33, in which the amount of the commodity is delivered to the investor at the end of the investment period.

36. A method of investing in a commodity which includes
investing funds in a financial institution which are utilised by the institution to purchase an amount of the commodity in accordance with the prevailing price of the commodity; and
receiving interest from the institution at a predetermined rate in respect of the funds invested.

37. A method of investing in a commodity, which includes
receiving funds from an investor;
purchasing an amount of the commodity in accordance with the prevailing price of the commodity; and
paying the investor interest at a predetermined rate in respect of the funds invested.

38. The method as claimed in claim 36, in which the rate is variable.

39. The method as claimed in claim 36, in which the rate is fixed.
